(19) United States
(12) Patent Application Publication
(10) Pub. No.: US 2025/0137459 A1
(43) Pub. Date: May 1, 2025

(54) TEMPERATURE CONTROL PUMP

(71) Applicant: TI Automotive Technology Center GmbH, Rastatt (DE)

(72) Inventor: Loic MARFING, Rastatt (DE)

(21) Appl. No.: 18/926,649

(22) Filed: Oct. 25, 2024

(30) Foreign Application Priority Data
Oct. 26, 2023 (DE) 102023129579.9

(51) Int. Cl. F04D 25/08; F04D 17/16; F04D 29/42

(52) U.S. Cl. CPC F04D 25/082; F04D 29/4206; F04D 17/16

(57) ABSTRACT

A pump comprises a stator and a rotor, wherein the rotor has a rotor body, a rotor block as well as a rotary bearing. The rotor or the rotor body, respectively, comprises an impeller and a shaft. The rotor body has a block housing, which at least partly encases the rotor block. For a secondary flow, the rotor preferably has several return ducts, which establish a fluidic connection between a drive chamber and an impeller chamber. The pump preferably comprises a rotationally non-movable axle, wherein the rotor is rotatably mounted on the axle.

### RELATED APPLICATIONS

The present disclosure claims priority to and the benefit of German Application 102023129579.9, filed on Oct. 26, 2023, the entire contents of each of which are incorporated herein by reference.

### FIELD

Pumps for driving a fluid, preferably a temperature control medium, in particular for the use in a vehicle, specifically for the use for the temperature control of a drive battery of an electric vehicle. In particular, coolant pumps having a block housing, which at least partly encases the rotor block.

### BACKGROUND

An electrically driven coolant pump with an external stator and an internal rotor is disclosed in EP 3 318 765 A1. The rotor comprises a rotor body, an upper and a lower rotary bearing as well as a rotor block with magnets. The rotor block is partly encased by a block housing. The rotor body has an impeller as well as a shaft. The shaft comprises a connecting section and the block housing, wherein the connecting section connects the block housing and the impeller in the axial direction. The rotor body is formed as injection molded part and thus integrally, wherein the block housing encloses the magnets in the axial direction. The two bearings are formed as sliding rotary bearings and allow the rotor to rotate about an axle with low friction. The upper bearing is additionally designed as tilting bearing in order to minimize the friction between an upper axle mount and the upper sliding bearing. The stator, the rotor and the control electronics of the pump heat up during operation and require a cooling. Said cooling is ensured by means of a secondary flow path, which comprises a return duct within the rotor close to the rotor block. The return duct is arranged precisely where the lower rotary bearing protrudes less. The space in the rotor body or in the shaft, respectively, is optimally utilized thereby.

A coolant pump, which likewise has a secondary flow path, is described in DE 10 2018 125 031 A1. For this purpose, the rotor has several return ducts, which cool the rotor block from its radial inner side. The rotor block is cooled even more hereby, while an imbalance of the rotor is reduced simultaneously by means of the plurality of return ducts and the wear is reduced. The rotor block is fastened to a central rotor shaft, so that the rotor shaft is rotatably mounted in a center wall. The rotor shaft protrudes through the center wall and drives an impeller. For this purpose, the center wall comprises a fixed rotary bearing, in which the rotor shaft can rotate. The rotary bearing does not overlap with the return ducts in the rotor body in the axial direction because the installation space is scarce. On its inner side, the rotary bearing instead has axially running grooves, which follow the return ducts of the rotor in the flow direction of the secondary flow. These stationary grooves connect the rotating return ducts of the rotor body to the impeller chamber, where the secondary flow mixes with the main flow.

The known coolant pumps are designed to cool a combustion engine and run at full load only when the combustion engine has already warmed up for a while. The known coolant pumps are thereby supported in particular by the airstream.

### BRIEF SUMMARY

The present disclosure provides a pump for the thermal management of an electric vehicle (“temperature control pump”) which is more efficient and reasonably priced at the same time.

The energy and mobility transition requires the development of new technologies, which include in particular electric vehicles with a drive battery and an electric motor. At temperatures of around 20° C., drive batteries achieve the largest efficiency, so that they have to be heated up or cooled, depending on the situation. A heat-up is expedient in particular shortly after the start-up in the winter, while a cooling can be considered especially when the vehicle has already driven for a while. The thermal management of the drive train in the case of electric vehicles differs from combustion vehicles in this respect especially during the cold season. The entire component chain (tubes, quick connectors, pumps, battery housings, etc.) of the thermal management in the case of electric vehicles has to ultimately be designed to additionally also work during the cold season and thus without support from the airstream. This means that-viewed over the course of a year-a relatively large flow rate of the temperature control fluid of the electric vehicle is required. As a result, the cooling pump or temperature control pump, respectively, has to be formed to be correspondingly efficient.

The present disclosure provides a pump for driving a fluid, preferably a temperature control medium, in particular for the use in a vehicle, specifically for the use for the temperature control of a drive battery of an electric vehicle, wherein the pump comprises a stator and a rotor, wherein the rotor comprises a rotor body, a rotor block as well as a rotary bearing, wherein the rotor is rotatably mounted about an axis of rotation, wherein the rotor or rotor body, respectively, has an impeller and a shaft, wherein the rotor or the rotor body, respectively, comprises a block housing, which at least partly encases the rotor block, wherein at least one section of an inlet of the pump is arranged in an axially upper half of the pump, wherein the pump comprises an outlet. This provides for the design of the pump that is more efficient and less costly.

It is preferred that the pump comprises a housing and a separating wall, wherein the separating wall separates a space within the housing into a wet region and a dry region. The wet region advantageously has an impeller chamber and a drive chamber, wherein the impeller is located in the impeller chamber. The block housing is preferably arranged in the drive chamber. It is possible that the pump has a printed circuit board for controlling the pump operation. The stator and/or the printed circuit board is expediently located in the dry region. This allows for a protection of the electrical/electronic components and simultaneously for a flowing around the rotor.

The impeller is preferably expediently arranged between the inlet and the outlet in the flow direction of a main flow path of the fluid. The pump is advantageously formed so that a secondary flow path of the fluid branches off from the main flow path and the secondary flow path extends from the impeller chamber into the drive chamber. This provides for a cooling of the stator, rotor or rotor block, respectively and/or of the printed circuit board.

According to a preferred embodiment, the rotor or rotor body, respectively, has, for the secondary flow, at least one return duct and advantageously several return ducts, which establish a fluidic connection between the drive chamber and the impeller chamber. The return ducts are expediently separated from one another via separating elements of the rotor or rotor body, respectively. The invention is based on the realization that a lowest possible wear is a particularly critical aspect of the efficiency. A low wear is significant for the reduction of the repair probability with respect to the pump during the service life of the electric vehicle. It was found that the wear takes place especially on the rotary bearing of the rotor. In addition to the total operating performance (average number of rotations until the end of life of the pump), this wear is related especially to an occurring imbalance in the rotor. The invention is based on the realization that the provision of a plurality of return ducts within the rotor significantly reduces the imbalance thereof, whereby the wear is ultimately also reduced, the total operating performance is increased and the efficiency of the pump is improved.

It is preferred that the pump comprises a rotationally non-movable axle, wherein the rotor is rotatably mounted on the axle. This allows for a particularly low wear on the rotary bearing and promotes a long service life. The axle preferably comprises a metal, more preferably a steel and in particular a stainless steel.

The present disclosure is based on the discovery that a massive shaft without axial through bore for an axle can only be mounted axially in sections on an external rotary bearing. This is so because other axial sections of the massive shaft have to perform other tasks and are assigned in particular to the rotor block or the impeller, respectively. As a result, the axial length of the external rotary bearing of a massive shaft is relatively short compared to the total length of the shaft.

In the case of an axle, in contrast, the rotor block and the rotary bearing or internal rotary bearing, respectively, can overlap in the axial direction over a longer section, so that in a system with an axle, a relatively larger rotary bearing length can be achieved. In the case of an axle system, the rotor runs more smoothly as a whole hereby, which leads to a lower wear, a longer service life and, as a result, to a more efficient pump.

The axis of rotation A defines an axial, a radial as well as a tangential direction or direction of circulation, respectively. The direction of circulation preferably relates to the top view and thus to the view from the outside into the inlet. The direction of rotation of the rotor expediently runs clockwise in the direction of circulation. The expression “axially inwards” preferably refers to the flow direction of the fluid in the inlet. The flow direction of the fluid in the inlet just in front of the impeller or the spider, respectively, is preferably directed from “top” to “bottom”. The expression “axially inwards” therefore corresponds to the expression “from top to bottom”.

The rotor block preferably comprises a rotor core. The rotor block preferably has magnets and in particular permanent magnets. The rotor block or the rotor core, respectively, is expediently formed in an approximately ring-shaped manner in a cross section. The magnets are preferably fastened to a radial outer side of the rotor core. It is highly preferred that the rotor core has a plurality of rotor sheets, which are stacked one on top of the other. The rotor sheets are preferably electrical sheets. The rotor sheets can be connected to one another to form the rotor core by means of punch-packaging or by means of bonding varnish. It is advantageous that the rotor sheets are provided with an insulating coating.

The rotor block and the block housing expediently form a drive section of the rotor in the axial direction. In the axial direction between the drive section and the impeller, the rotor preferably comprises a connecting section. The drive section and the connecting section of the rotor or of the rotor body, respectively, expediently form the shaft. It is preferred that the block housing or the drive section, respectively, divides the drive chamber into an upper hollow space above the block housing and advantageously into a lower hollow space below the block housing.

It is possible that the rotary bearing is exposed to a rotatory sliding movement with its radial inner side or its radial outer side. The rotary bearing can be made of the same material as the rotor body and can in particular be an integral part of the rotor body. The rotary bearing can be made of a different material than the rotor body.

The housing preferably comprises an upper housing part and a lower housing part. The printed circuit board is preferably arranged between the separating wall and the lower housing part—in particular in the axial direction. The stator is preferably arranged between the separating wall and the lower housing part—in particular in the radial direction. The rotor is advantageously located between the upper housing part and the separating wall—in particular in the axial direction.

The separating wall preferably comprises a bottom, a side wall, a collar and/or a separating wall flange. The upper housing part preferably has an upper housing flange. The lower housing part advantageously comprises a lower housing flange. The pump advantageously comprises a stator holder. The stator and the stator holder preferably form a stator aggregate. The stator holder advantageously has a holder flange.

The inlet is preferably formed coaxially to the rotor. This causes lower pressure losses on the impeller. A collecting duct circumferentially arranged around the impeller is preferably arranged for collecting the fluid, which is centrifuged radially outwards. It is preferred that clockwise, the collecting duct has a clear, increasing cross sectional surface. This has the effect that a constant pressure is provided along the collecting duct, whereby a relatively constant pressure drop is simultaneously also generated radially inwards along the collecting duct. The outlet is preferably formed as tangential extension of the circulation duct. Low pressure losses are attained hereby.

According to a preferred embodiment, the rotor has, in a longitudinal section of the pump, a protrusion for the turbulence reduction, wherein the protrusion protrudes in the radial direction and, with view towards an underside of the rotor, at least partly and preferably completely covers an input of a return duct and preferably all inputs of the return ducts. This effects a shielding of the return duct or of the return ducts, respectively, and of the separating elements from the/a lower hollow space, so that these turbulence-generating elements only have a very small influence on the fluid quantity in the lower hollow space. The rotor or the pump, respectively, runs more smoothly as a whole hereby and the power consumption of the pump is reduced. The protrusion preferably forces the fluid in the region of the input of the return duct or of the inputs of the return ducts, respectively, to deviate from a purely axial flow direction. The protrusion advantageously changes the input of the return duct or the inputs of the return ducts, respectively, so that a surface normal of the fluidically active or clear surface of the input, respectively, deviates from a purely axial expansion. More particularly preferably, the surface normal of the input into the return duct runs in a radial or purely radial direction, respectively, and in particular in an external radial direction or a purely radial, external direction, respectively.

It is preferred that the rotor has a rotor cap, wherein the rotor cap is fastened to a lower end of the rotor. The rotor cap can be fastened to the rotor or rotor body, respectively, by means of ultrasonic welding, for example. It is particularly preferred that the rotor cap has the protrusion for the turbulence reduction. This effects a simplification of the rotor body with regard to injection molding.

It is of great advantage when the rotor body is formed in one piece and preferably integrally—in particular by means of injection molding or overmolding, respectively. The one-piece design effects a relatively large stability, which is significant with regard to the service life and the large total number of rotations associated therewith. An integral setup of the rotor body in the form of an injection molding or an overmolding, respectively, has the effect that the number of parts and of connecting steps is reduced significantly and the production effort is thus kept small.

The impeller preferably comprises an impeller plate and/or blades for conducting the fluid. The blades are preferably connected in one piece and in particular integrally to the impeller plate. The rotor body preferably comprises the impeller plate and/or the blades. Between them, the blades expediently form blade ducts. The rotor or the rotor body, respectively, or the impeller, respectively, preferably has five and particularly preferably seven blades or blade ducts, respectively.

The rotor advantageously comprises an impeller cover. The impeller cover and the rotor body or the blades, respectively, are expediently plugged together and/or welded together. The impeller cover expediently serves for a closure of the impeller towards the top, so that it is not the blades but only a top side of the impeller cover, which can come into contact with the upper housing part. A wear of the blades is virtually ruled out hereby, whereby the service life of the pump is extended.

It is preferred that the rotor body or the block housing, respectively, encloses the rotor block in the radial direction at least along an axial section and at least along a circulation section. The rotor body or the block housing, respectively, preferably encloses the rotor block in the radial direction along the entire axial expansion of the rotor block and/or along a total circulation of the rotor block. The metallic components of the rotor block are shielded from the fluid hereby. The enclosing of the rotor block by the rotor body or the block housing, respectively, additionally serves for a smoothening of the outer side of the rotor block, so that the metallic parts of the rotor block cannot damage the separating wall. And lastly, the enclosing of the rotor block has the effect that a particularly smooth, radial outer side of the drive section of the rotor is generated, whereby the turbulence generation by means of the drive section is reduced to a minimum.

According to a preferred embodiment, the printed circuit board is arranged on an outer side of the separating wall. The printed circuit board preferably comprises electronic control units, for example transistors and in particular MOSFETs. It is advantageous that the printed circuit board is arranged on a/the bottom of the separating wall. It is highly preferred that a heat conducting element is located between the printed circuit board and the separating wall. The heat conducting element advantageously comprises a heat conducting paste. The electronic control units preferably touch the heat conducting paste or the heat conducting element, respectively. A particularly favorable dissipation of the heat arising at the printed circuit board is ensured hereby. It is preferred that the printed circuit board has an electrical connection for the connection to the stator. The electrical connection is preferably mechanically supported by a support element. From a mechanical aspect, the printed circuit board is thus held mechanically not only via the electrical connection to the stator but also via the support element. It is preferred that the printed circuit board comprises a second support element. With respect to the axis of rotation A, the second support element is arranged in a region of the printed circuit board, which lies opposite a region of the first support element on the printed circuit board. The second support element expediently connects the printed circuit board to the stator or the stator holder, respectively, or the stator aggregate, respectively.

It is advantageous when the return ducts are located within the rotor or rotor body, respectively. The rotor or the rotor body, respectively, advantageously completely encloses at least one return duct and preferably all return ducts in a cross section at least axially section by section. The respective complete enclosing of the return duct or of the return ducts, respectively, by means of the rotor body has the effect that the boundary surfaces within the rotor (e.g., between rotor body and rotor block or between rotor body and rotary bearing) are formed particularly evenly. Fewer edges are created hereby, so that the rotor gains stability and in particular becomes less prone to wear. This applies in particular for boundary surfaces, which slide on top of each other during the pump operation. However, this also applies for boundary surfaces within the rotor, which do not slide on top of each other. If grooves are located there, then these grooves often lead to edges or to unwanted artefacts as a whole, so that, for example, the flow behavior of the fluid in the return ducts can be negatively impacted.

According to a preferred embodiment, the rotary bearing has an effective axial rotary bearing length DL, wherein the axle has an effective axle length AL. It is preferred that the ratio DL/AL is larger than or equal to 0, 40 or 0.45, respectively, or 0.50, respectively, or 0.55, respectively, or 0.60, respectively, or 0.65, respectively, or 0.70, respectively. The term “effective axial rotary bearing length” preferably refers to that axial length of that surface of the rotary bearing, which is in contact with the axle. The expression “effective axle length” preferably refers to that axial length of the axle, with which the axle protrudes from the bottom of the separating wall and which simultaneously provides a contact surface for the rotary bearing or the axle holder, respectively. For example, a chamfer at an upper end of the axle does not contribute to the effective axle length AL. In particular the axial section of the axle, which is enclosed by the separating wall or by the bottom of the separating wall, respectively, does not contribute to the effective axle length. A ratio DL/AL, which is as large as possible, has the effect that the wear is minimized because the forces acting on the rotary bearing and the axle are distributed to a very large surface or a rotary bearing, which is expanded very far.

It is preferred that the pump has an axle holder. It is advantageous that the axle holder is arranged in an upper half or an upper third, respectively, or an upper quarter, respectively, of the axle. The axle holder preferably comprises a metal, more preferably a steel and in particular a stainless steel. It is highly preferred that the axle holder encloses the axle at least partly and preferably completely in the direction of circulation. It is preferred that the axle—at least in a partly disassembled state of the pump—can slide in the axial direction in the axle holder and advantageously does not have a radial play in the axle holder at its disposal at the same time.

The axle holder has an effective axial holder length HL. The term “effective axial holder length” preferably refers to that axial length of the axle holder, along which the axle holder is in contact with the axle. In particular a chamfer on a radial inner side of the axle holder does not contribute to the effective axial holder length HL. It is very particularly preferred that a ratio HL/AL is at least 0.07 or 0.10, respectively, or 0.13, respectively, or 0.15, respectively, or 0.17. This effects a particularly stable mounting of the axle at its upper end, whereby a smoother running and a lower wear are attained.

It is highly advantageous when a ratio (DL+HL)/AL is at least 0.5 or 0.6, respectively, or 0.7, respectively, or 0.8, respectively, or 0.9, respectively. This has the effect that as little effective axle length as possible remains unused. It is a realization of this invention that the effective axle length AL provided by the axle is to be utilized as much as possible and should be used in particular for a rotary bearing, which is axially as expanded as possible as well as for an axle holder, which is as axially expanded as possible. A ratio of DL/HL is advantageously 1 to 10, preferably 2 to 7 and very particularly preferably 2.5 to 5 and most preferably 3 to 4.

It is advantageous when the rotor has some axial play on the axle at its disposal in a standstill of the pump or in a state without fluid, respectively. It is possible that in a state with standing fluid or in a state without fluid, the rotor does not rest against the axle holder. It is highly preferred that the pump is formed so that the rotor or the rotor body, respectively, or the rotary bearing, respectively, rests with an upper axial front surface on a lower axial front surface of the axle holder during the pump operation. The upper, axial front surface of the rotary bearing and the lower, axial front surface of the axle holder are expediently exposed to a sliding friction to one another. It is highly preferred that the upper axial front surface of the rotary bearing is identical, with respect to its surface area, to the surface area of the lower axial front surface of the axle holder. The axial play allows for varying degrees of secondary flows-depending on the rotational speed and thus depending on the generated pressure. In the case of high pressure in the collecting duct, a correspondingly strong secondary flow also generates a larger pressure in the drive chamber, which raises the rotor maximally until it strikes against the axle holder. The cooling of the electrical components is adapted hereby depending on the pumping capacity.

It is preferred that a radial expansion of the upper axial front surface of the rotary bearing is larger than a radial expansion of the rotary bearing in a lower region. The rotary bearing preferably comprises a flange in an upper half or an upper third, respectively, or quarter, respectively. This allows for a good positive connection to the rotor body and increases the stability of the rotor.

It is preferred that the rotary bearing rests against the axle or is groove-free, respectively, along at least one axial section over a full circumference. The rotary bearing is formed to be particularly stable hereby, instead of having to additionally also take over the task of the fluid conductance on its inner side.

The rotary bearing preferably comprises a different material than the rotor body or the shaft, respectively, or the impeller, respectively. The rotary bearing advantageously comprises carbon and in particular a graphite. The rotary bearing preferably has a binding agent and in particular a polymer. It is advantageous that the rotary bearing is not integrally connected to the impeller or is not an integral part of the rotor body, respectively. It is achieved hereby that the rotor is provided on the one hand with a good sliding property via the rotary bearing with a material, which is optimized for the sliding friction. The material of the rotor body is simultaneously optimized for the force transmission and in particular for the transmission of torsional forces, so that materials other than those for the rotary bearing can be considered for the rotor body or the shaft, respectively. The rotor body advantageously has a thermoplastic, preferably a technical thermoplastic, more preferably a high-performance thermoplastic and, for example, a polyphenylene sulfide (PPS).

A spider is advantageously arranged in the flow direction between the inlet and the impeller. The spider is preferably fastened to the housing or the upper housing part, respectively. The spider preferably has at least two and more preferably at least three legs. Very particularly preferably, the spider comprises exactly three legs. The legs of the spider are preferably arranged or fastened, respectively, to an inner side of the inlet. It is advantageous that the spider is connected in one piece and preferably integrally to the inlet or to the upper housing part, respectively, or to the housing, respectively. On its underside, the spider expediently comprises a receptacle for inserting the axle holder. The axle holder is preferably pressed into the receptacle of the spider. The spider has the effect that a relatively low-turbulence fastening of the axle holder to the housing is made possible hereby.

According to a preferred embodiment, an annular gap runs between a radial outer side of the drive section or of the block housing, respectively, and an inner side of the separating wall or of the inner side of the side wall of the separating wall, respectively. The secondary flow path advantageously has the annular gap. The annular gap preferably fluidically connects an/the upper hollow space of the drive chamber to a/the lower hollow space of the drive chamber. This has the effect that the fluid cools the inner side of the stator as well as the outer side of the rotor block.

It is preferred that the impeller or the impeller plate and the collecting duct, respectively, or the separating wall, respectively, or the collar of the separating wall, respectively, form a circumferential gap, which fluidically connects the collecting duct or the impeller chamber, respectively, to the drive chamber or the upper hollow space of the drive chamber, respectively. Due to the virtually complete circulation, the circumferential gap provides for the passage of a relevant liquid quantity, so that the stator, the rotor block and the printed circuit board are cooled sufficiently. The circumferential gap simultaneously provides for the avoidance of turbulences. If there were a plurality of defined ducts from the collecting duct into the upper hollow space, for example, the respective inputs and outputs would each generate turbulences. As a result, the circumferential gap as a whole is somewhat more favorable compared to individual ducts from a fluid dynamic aspect.

According to a preferred embodiment, the separating wall has ribs on its inner side-preferably in a lower region of the drive chamber. Ribs are expediently arranged on an inner side of the bottom of the separating wall. This effects a reinforcement of the bottom or of the separating wall, respectively, and thus an improvement of the axle stability. This, in turn, promotes the smooth running of the pump and reduces the wear. Compared to a massive design of the bottom, the ribs are furthermore advantageous because the thick-walled regions can easily lead to imperfections during the injection molding. This includes, in particular cavities as well as material shrinkage. The ribs preferably run in the radial direction with its longitudinal expansion.

On its inner side, the separating wall or the bottom of the separating wall, respectively, advantageously comprises an axle fixation. The axle fixation is expediently arranged in a longitudinal section in the center of the bottom or of the separating wall, respectively. The axle fixation is preferably a one-piece and in particular integral part of the bottom or of the separating wall, respectively. It is very particularly preferred that the axle fixation is produced by means of overmolding of the axle. In an axial section overmolded by the axle fixation, the axle advantageously comprises an asymmetric region. This serves the purpose of avoiding rotation of the axle in the axle fixation or in the bottom, respectively, or in the separating wall, respectively.

According to a preferred embodiment, the separating wall has a thermoplastic, preferably a technical thermoplastic, more preferably a high-performance thermoplastic and particularly preferably a polyphenylene sulfide (PPS). It is highly preferred that the separating wall comprises a conductivity additive for increasing the thermal conductivity. The conductivity additive preferably has carbon and more preferably a graphite.

The pump advantageously comprises a stator holder. It is preferred that the stator holder has a holder flange. The holder flange preferably rests against a housing flange, in particular against the upper housing flange and/or the lower housing flange and particularly preferably against the lower housing flange. This allows for a very quick assembly of the pump because the stator holder can be inserted into the lower housing part with the entire stator. The holder flange advantageously rests against a/the separating wall flange. The holder flange is expediently arranged in the axial direction between the separating wall flange and the lower housing flange. It is preferred that the separating wall flange rests against the upper housing flange and/or the holder flange. The separating wall flange is preferably arranged between the upper housing flange and the holder flange or the lower housing flange, respectively. It is preferred that a fastening device—in particular, a screw device-clamps together or engages through, respectively, the upper housing flange, the separating wall flange, the holder flange and/or the lower housing flange. This provides for a quick fixation of all, larger components of the pump.

According to a preferred embodiment, the pump comprises a lower housing part, a stator aggregate, a separating wall aggregate and an upper housing part, wherein the stator aggregate has the stator and preferably a/the stator holder, wherein the separating wall aggregate comprises the separating wall and preferably an/the axle, wherein the pump can be assembled in the order
lower housing part
stator aggregate
separating wall aggregate
rotor
upper housing part
   or in the reverse order. The fact that these two orders are possible during the assembly does not exclude other orders. For example, the rotor can be placed onto the axle of the separating wall aggregate, in order to then place the separating wall aggregate onto the stator aggregate together with the rotor.

It is advantageous that the stator aggregate has the printed circuit board. According to a preferred embodiment, the lower housing part has outer electrical connections. It is preferred that the outer, electrical connections can be connected or are connected, respectively, to the printed circuit board via cables. The cables are expediently connected to the lower housing part and the printed circuit board before the stator aggregate is placed into the lower housing part or before the lower housing part is placed onto the stator aggregate.

### BRIEF DESCRIPTION OF THE DRAWINGS

The present disclosure will be described in more detail below on the basis of an exemplary embodiment with figures, in which

FIG. 1 shows a longitudinal section through a pump according to the invention,

FIG. 2 shows a perspective view of an enlarged section from FIG. 1,

FIG. 3 shows a top view onto a rotor body of the pump from FIG. 1, and

FIG. 4 shows a bottom view of the rotor body from FIG. 1.

### DETAILED DESCRIPTION

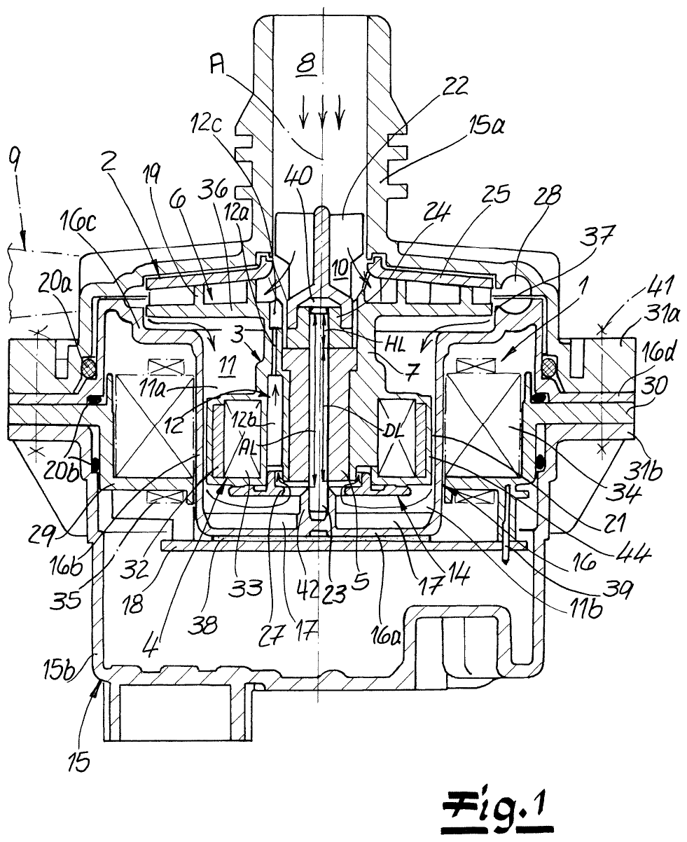

A pump, which is preferably used in a vehicle and particularly preferably for the temperature control of a drive battery of an electric vehicle, is illustrated in FIG. 1. The pump is in particular a temperature control pump, which drives a temperature control medium through a fluid line to a drive battery of an electric vehicle.

The pump expediently comprises an inlet 8 as well as an outlet 9, which is only illustrated in a dashed manner in FIG. 1 due to the selected section. The pump comprises an impeller 6, which operates clockwise. The fluid coming from the inlet 8 is centrifuged outwards and advantageous into a circumferential collecting duct 28 hereby. It is preferred that a clear cross section of the collecting duct 28 increases clockwise to the outlet 9 in order to keep the pressure in the collecting duct 28 approximately constant along its preferably almost complete circulation. The path of the fluid from the inlet 8 to the outlet 9 via the impeller 6 and the collecting duct 28 is the main flow path for the fluid provided by the pump. The impeller 6 of this exemplary embodiment comprises a total of seven blades 19, which centrifuge the fluid radially outwards.

The pump is electrically driven, for the purpose of which the pump comprises a stator 1 and a rotor 2. The rotor 2 is expediently arranged within the stator 1. The stator 1 may comprise a stator core 34, which is illustrated in a simplified manner, as well as stator windings 35, which are illustrated in a simplified manner. The stator core 34 can be formed in the known manner as circumferential ring with several pole shoes. It is possible that the stator core 34 is made of a stack of stator sheets. The stator 1 is preferably arranged on or at a stator holder 29, respectively. The pump expediently comprises a housing 15. In this exemplary embodiment, the housing 15 comprises an upper housing part 15a and a lower housing part 15b.

The rotor 2 comprises a rotor body 3, a rotor block 4, a rotary bearing 5 and/or an impeller 6. The rotor 2 is preferably rotatably mounted about an axis of rotation A on a rotationally fixed axle 23. The axle 23 preferably comprises a metal, more preferably a steel and in particular a stainless steel. It is preferred that the axle 23 tapers at its upper end via a chamfer.

The rotor 2 of this exemplary embodiment comprises a impeller cover 25, which closes or covers, respectively, the impeller 6 towards the inlet 8 or towards the top, respectively. The impeller cover 25 can have a central opening. The impeller 6 is expediently located within a impeller chamber 10 formed by the housing 15. It is highly preferred that the rotor 2 or the rotor body 3, respectively, or the impeller 6, respectively, comprises several and preferably seven blades 19 and/or a impeller plate 36.

The rotor block 4 of this exemplary embodiment comprises a rotor core 33 and expediently magnets 32. The magnets 32 can be designed in the shape of a cuboid or slightly curved and are advantageously arranged on a radial outer side of the rotor core 33.

The rotor 2 or the rotor body 3, respectively preferably comprises a block housing 44, which at least partly and in this exemplary embodiment completely encases the rotor block 4. The rotor body 3 or the block housing 44, respectively, advantageously comprises a plastic and is preferably produced by means of overmolding of the rotor block 4 and/or of the rotary bearing 5.

The rotor 2 or rotor body 3, respectively, advantageously has a shaft 7. It is preferred that the shaft 7 comprises a drive section and/or a connecting section in the axial direction. The drive section advantageously comprises the block housing 44. It is preferred that the connecting section is arranged in the axial direction between the drive section or block housing 44, respectively, and the impeller 6 or the impeller plate 36, respectively.

The pump preferably has a separating wall 16. The separating wall 16 preferably comprises a plastic, in particular a technical plastic, more preferably a high-performance plastic and in particular polyphenylene sulfide (PPS). The separating wall 16 advantageously has a conductivity additive for increasing the thermal conductivity. The conductivity additive can in particular comprise a plastic, preferably graphite. It is advantageous that the separating wall 16 is formed in one piece and in particular integrally. The separating wall 16 preferably has a bottom 16a, a side wall 16b, a collar 16c and/or a separating wall flange 16d.

The separating wall 16 or the bottom 16a, respectively, preferably comprises an axle fixation 42. The axle fixation is advantageously connected in one piece and in particular integrally to the bottom 16a or the separating wall 16, respectively. The axle 23 is preferably fixed in the separating wall or in the bottom 16a, respectively—in particular to the axle fixation 42. The axle fixation 42 is advantageously produced by means of overmolding around a lower end region of the axle 23. In this exemplary embodiment, the bottom 16a comprises several ribs 17, which reinforce the bottom 16a or the axle fixation 42, respectively.

The side wall 16b or the separating wall, respectively, of this exemplary embodiment is expediently formed hollow cylindrically and may define a drive chamber 11 in the radial direction. The drive chamber is preferably delimited by the bottom 16a or the impeller 6, respectively, or the impeller plate 36, respectively, in the axial direction. The rotor 2 or the rotor block 4, respectively, is preferably located within the drive chamber 11. An upper hollow space is advantageously located in the axial direction between the block housing 44 and the impeller or impeller plate 36, respectively. A lower hollow space is expediently located in the axial direction between the block housing 44 and the bottom 16a. An annular gap 21 is preferably located between the side wall 16b and the block housing 44 or the drive section of the shaft 7, respectively, or of the rotor 2, respectively.

The collar 16c can in particular define a portion of the impeller chamber 10 and/or a portion of the collecting duct 28-preferably together with the upper housing part 15a. The collar 16c is preferably located in an upper half of the separating wall. The separating wall flange 16d is preferably recessed downwards with respect to the collar 16c.

The separating wall 16 expediently separates a or the space within the housing 15, respectively, into a wet region and a dry region. The wet region advantageously corresponds to the inner volume formed by the upper housing part 15a and the separating wall 16. The dry region preferably corresponds to an inner volume formed by the separating wall 16 and the lower housing part 15b. It is preferred that a fluid seal 20a is arranged between the upper housing part 15a and the separating wall 16. In this exemplary embodiment, the fluid seal 20a encloses the separating wall 16 in the radial direction.

The pump expediently comprises a printed circuit board 18 for controlling the pump operation. The printed circuit board 18 is advantageously located in the dry region of the pump. It is preferred that the printed circuit board 18 is in contact with a heat conducting element 38. The heat conducting element 38 can be a heat conducting paste, for example. The heat conducting element 38 is preferably in contact with an outer side of the separating wall 16 or of the bottom 16a, respectively.

It is possible that the printed circuit board has an electrical connection 39 to the stator 1. It is possible that the printed circuit board 18 is fastened to the stator holder in a region lying radially opposite the electrical connection 39. It is preferred that electrical connections (not illustrated) are located at the lower housing part 15b. The printed circuit board 18 can in particular have electronic control elements—for example MOSFETs-which cause a noteworthy portion of the heat generation of the printed circuit board 18.

The collecting duct 28 or the separating wall 16, respectively, or the collar 16c and the rotor 2, respectively, or the impeller 6, respectively, or the impeller plate 36, respectively, preferably form a circumferential gap 37. It is preferred that a secondary flow of the fluid branches off from the main flow of the fluid through this circumferential gap. The secondary flow expediently follows a secondary flow path specified by the pump. The secondary flow forms due to a pressure difference between regions lying radially further on the outside and regions lying radially further on the inside. The secondary flow initially flows into the upper hollow space 11a and then preferably through the annular gap 21. In the further course, the secondary flow then advantageously reaches the lower hollow space 11b.

The rotor 2 or rotor body 3, respectively, particularly preferably comprises at least one return duct 12 for the secondary flow and preferably several return ducts 12, which establishes/establish a fluidic connection between the drive chamber 11 and the impeller chamber 10. The return ducts 12 are expediently separated from one another via separating elements 13 of the rotor 2 or rotor body 3, respectively. The return ducts 12 preferably comprise a lower section 12b, an upper section 12a as well as an output 12c. The cross sectional surface of the lower section 12b is advantageously larger than that of the upper section 12a.

From the lower hollow space 11b, the secondary flow flows upwards through the return ducts 12 through the rotor 2 or the rotor body 3, respectively, back into the impeller chamber 10. A lower pressure prevails at the output 12c of the return duct 12 compared to the pressure within the collecting duct 28, whereby the secondary flow forms. The secondary flow entrains the heat of the stator 1, of the printed circuit board 18 and of the rotor block 4 and mixes with the main flow in a radially inner region of the impeller chamber 10.

The lower section 12b of the return ducts 12 preferably overlaps with the rotor block 4 at least partly in the axial direction. A wall between the rotor block 4 and the lower section of the return duct 12 is relatively thin hereby, whereby the heat can be removed well.

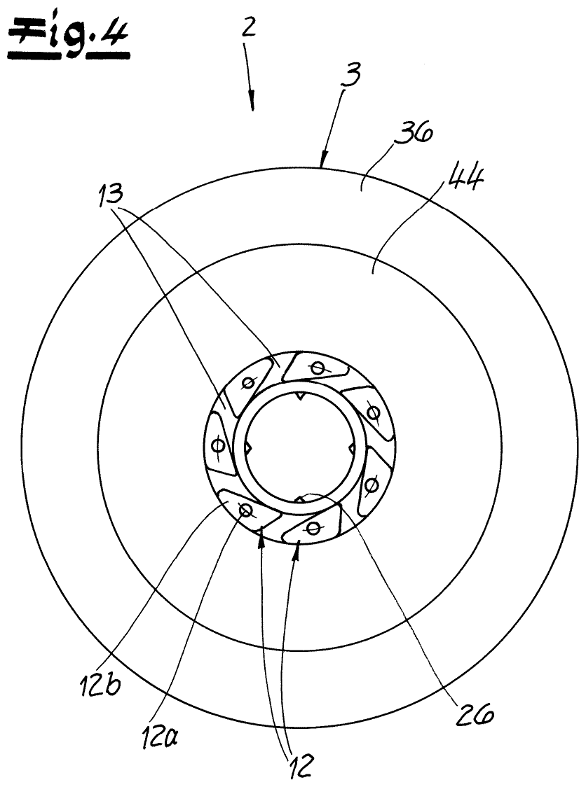

The return ducts 12 are preferably separated from one another by means of separating elements 13 along the lower section 12b of the return ducts 12. The separating elements 13 can in particular be seen in FIG. 4 and can in particular be formed as webs or ribs. The separating elements 13 expediently connect the wall of the rotor body 3 between the rotor block 4 and the return duct 12 on the one side to a wall of the rotor body 3 on the other side, which directly encloses the rotary bearing 5. The separating element 13 stabilize a/the shaft 7 of the rotor 2 or of the rotor body 3, respectively, in this way. In particular the separating elements 13 simultaneously cause significant turbulences in the lower hollow chamber 11b, whereby losses occur.

It is highly preferred that the rotor 2 has a protrusion 27, which protrudes in the radial direction-preferably radially inwards—and at least partly covers an input of the return duct 12 or of the return ducts 12, respectively, with view towards an underside of the rotor 2. In the present exemplary embodiment, the protrusion 27 completely covers the input of the return duct 12 illustrated in FIG. 1.

It is preferred that the rotor 2 comprises a rotor cap 14, wherein the rotor cap 14 is preferably fastened to a lower end of the rotor 2. The rotor cap 14 can be connected to an underside of the rotor body 3, for example by means of ultrasonic welding. Very particularly preferably, the rotor cap 14 comprises the protrusion 27. The protrusion 27 or the rotor cap 14, respectively, shields the separating elements 13 from the lower hollow space 11b, whereby the turbulences are limited to a very much smaller space and the losses are significantly reduced in this region due to turbulences.

The rotary bearing 5 preferably comprises a carbon and in particular a graphite. The rotary bearing 5 preferably has a binding agent and in particular a polymer. The axle 23 has an effective length AL, which corresponds to that axial length, with which the axle 23 protrudes from the axle fixation 42 or the bottom 16a, respectively, and with which contact surfaces for the rotary bearing 5 are provided. The rotary bearing 5 has an effective rotary bearing length DL, which corresponds to a provided axial contact length between the rotary bearing 5 and the axle 23. The ratio DL/AL corresponds to 0.72 in this exemplary embodiment.

A spider 22 is preferably arranged in the flow direction between the inlet 8 and the impeller 6. The spider 22 of this exemplary embodiment comprises three legs, which are fastened to an inner side of the inlet 8. The spider 22 preferably has a receptacle 40 on its underside.

In this exemplary embodiment, an axle holder 24 is pressed into the receptacle 40. The axle holder preferably comprises a metal and in particular a steel or stainless steel, respectively. The axle holder 24 advantageously allows an axial sliding to the axle 23, but no radial play. It is preferred that the rotary bearing 5 can slide axially on the axle 23 and can rotate about the axle 23, but does not have a radial play to the axle 23. The axle holder has an effective length HL in the axial direction, which corresponds to a contact length with the axle 23. A ratio HL/AL preferably corresponds to at least 0.07 or 0.10, respectively, or 0.12, respectively, or 0.14, respectively, or 0.16, respectively. It is highly preferred that the sum of DL+HL corresponds to at least 0.5 or 0.6, respectively, or 0.7, respectively, or 0.8, respectively, or 0.9, respectively.

The lower housing part 15b preferably corresponds to a lower housing flange 31b. The lower housing flange 31b advantageously rests against the holder flange 30 of the stator holder 29. It is preferred that the holder flange 30 rests against the separating wall flange 16d. The holder flange 30 is preferably arranged between the separating wall flange 16d and the lower housing flange 31b. It is preferred that the separating wall flange 16d is located between the upper housing flange 31a and the holder flange 30 or the lower housing flange 31b, respectively.

It is highly preferred that the upper housing flange 31a, the separating wall flange 16d, the holder flange 30 and/or the lower housing flange 31b are pressed together by means of a fastening device. The fastening device is preferably a screw connection. It is more particularly preferred that the fastening device 41 or the screw device, respectively, engages through the upper housing flange 31a, the separating wall flange 16d, the holder flange 30 and/or the lower housing flange 31b, respectively.

It is possible that the pump has at least one holder seal 20b and preferably two holder seals 20b. In this exemplary embodiment, a holder seal 20b is arranged between the stator holder 29 and the lower housing part 15b in a longitudinal section of the pump. It is possible that a holder seal 20b is arranged between the stator holder 29 and the separating wall 16.

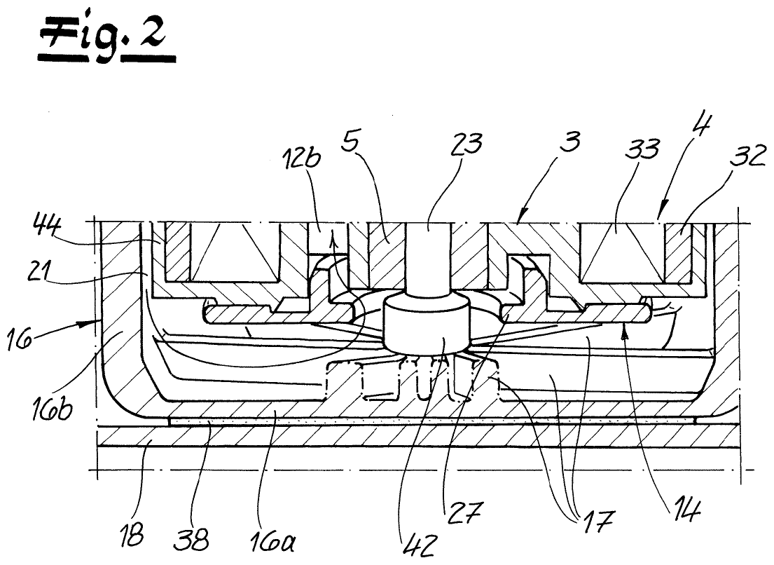

The bottom 16a of the separating wall 16 is illustrated perspectively or as an isometric in FIG. 2, so that a preferred star-shaped arrangement of the ribs 17 of this exemplary embodiment becomes visible. The ribs 17 preferably run with their longitudinal expansion from a radially outer region of the bottom 16a to a radially inner region of the bottom 16a or to the axle fixation 42, respectively, in the radial center of the bottom 16a. The lower end of the axle 23 overmolded by the axle fixation 42 can have an asymmetry—for example, a groove-whereby a rotationally fixed fixation of the axle 23 in the bottom 16a or in the axle fixation 42, respectively, is ensured. This stable bottom structure or axle fixation 42, respectively, in connection with the likewise stable axle holder 24, allows for an exact positioning of the axle. In particular a very smooth running of the rotor 2 around the axle 23 is ensured hereby, which is in particular also supported by the rotary bearing 5, which is expanded to be very long. As a result, a very smooth running and a low wear are attained.

The structure of the rotor cap 14 can further be seen slightly better in FIG. 2. A further protrusion of the rotor cap extends in the axial direction into the return duct 12 or into the return ducts 12, respectively. This further protrusion essentially has the purpose of the correct positioning of the rotor cap 14 on the rotor 2.

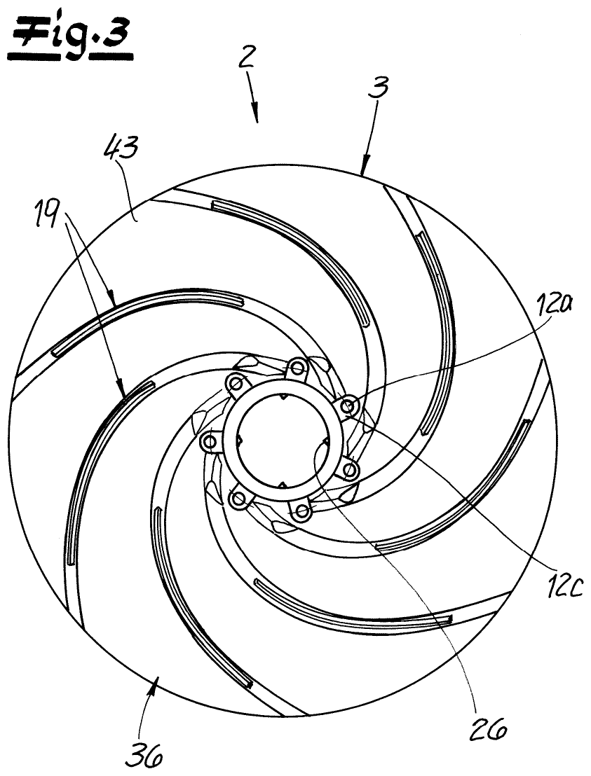

A top view of the rotor body 3 is illustrated in FIG. 3, so that the upper sections 12a and the outputs 12c of the return ducts 12 can be seen. It is preferred that each output is assigned to a blade 19 or a blade duct 43, respectively. On their top side, the blades 19 preferably comprise plug elements for engagement with the impeller cover 25, which is not illustrated in FIG. 3. On its radial inner side, the rotor body 3 preferably comprises engagement elements 26, which are brought into an engagement with the rotary bearing 5, which is not illustrated in FIG. 3. In this exemplary embodiment, the rotary bearing 5 comprises, on its outer side, four axially running grooves, which are formed complementary to the engagement elements 26 of the rotor body 3 in FIG. 3.

Finally, a bottom view of the rotor body 3 is shown in FIG. 4, wherein the rotor cap 14—as well as all other elements with the exception of the rotor body 3—were omitted for the sake of simplicity. The return ducts 12 as well as the separating elements 13 can now be seen well. The separating elements 13 are preferably formed in a web-like manner. The separating elements 13 advantageously extend in the tangential direction in a cross section of the rotor body 3. The separating elements 13 rotate clockwise, so that the selected tangential alignment of the separating elements 13 represents a first turbulence reducing measure. This measure is in particular also supplemented by means of the rotor cap 14, which is not illustrated in FIG. 4.

It can be seen well in FIG. 4 that with respect to its cross sectional surface, the lower section 12b of each return duct 12 is preferably significantly larger than an upper section 12a of the respective return duct 12. The lower sections 12b of the return ducts 12 provide a large volume in order to cool the rotor block 4 in the best possible way. A larger volume of the lower section 12b of the return ducts 12 would only be possible at the expense of thinner separating elements 13 or a thinner inner wall of the rotor body 3, which rests against the rotary bearing 5. On the one hand, the upper sections of the return ducts 12a are quite small so that they can be better assigned to the induvial blade ducts 43.

List of Reference Numerals

| A | axis of rotation |
|---|---|
| 1 | stator |
| 2 | rotor |
| 3 | rotor body |
| 4 | rotor block |
| 5 | rotary bearing |
| 6 | impeller |
| 7 | shaft |
| 8 | inlet |
| 9 | outlet |
| 10 | impeller chamber |
| 11 | drive chamber |
| 11a | upper hollow space |
| 11b | lower hollow space |
| 12 | return ducts |
| 12a | upper section |
| 12b | lower section |
| 12c | output |
| 13 | separating elements |
| 14 | rotor cap |
| 15 | housing |
| 15a | upper housing part |
| 15b | lower housing part |
| 16 | separating wall |
| 16a | bottom |
| 16b | side wall |
| 16c | collar |
| 16d | separating wall flange |
| 17 | ribs of 16 |
| 18 | printed circuit board |
| 19 | blade of 6 |
| 20a | fluid seal |
| 20b | holder seals |
| 21 | annular gap |
| 22 | spider |
| 23 | axle |
| 24 | axle holder |
| 25 | impeller cover of 2 |
| 26 | engagement element of 3 |
| 27 | protrusion of 2, 14 |
| 28 | collecting duct |
| 29 | stator holder |
| 30 | holder flange |
| 31a | upper housing flange of 15a |
| 31b | lower housing flange of 15b |
| 32 | magnets |
| 33 | rotor core |
| 34 | stator core |
| 35 | stator windings |
| 36 | impeller plate |
| 37 | circumferential gap |
| 38 | heat conducting element |
| 39 | electrical connection |
| 40 | receptacle of 22 |
| 41 | fastening device |
| 42 | axle fixation |
| 43 | blade duct |
| 44 | block housing |

1. A pump for driving a fluid, preferably a temperature control medium, for use for the temperature control of a drive battery of an electric vehicle, wherein the pump comprises a stator and a rotor, wherein the rotor comprises a rotor body, a rotor block and a rotary bearing, wherein the rotor is rotably mounted about an axis of rotation (A), wherein the rotor or rotor body, respectively, has an impeller and a shaft, wherein the rotor or the rotor body comprises a block housing, which at least partly encases the rotor block, wherein at least one section of an inlet of the pump is arranged in an axially upper half of the pump, wherein the pump includes an outlet.

2. The pump according to claim 1, wherein the pump comprises a housing and a separating wall, wherein the separating wall separates a space within the housing into a wet region and a dry region, wherein the wet region has an impeller chamber and a drive chamber, wherein the impeller is located in the impeller chamber, wherein the block housing is arranged in the drive chamber.

3. The pump according to claim 1, wherein the impeller is arranged between the inlet and the outlet in the flow direction of a main flow path of the fluid, wherein the pump is preferably formed so that a secondary flow path of the fluid branches off from the main flow path and the secondary flow path extends from the impeller chamber into the drive chamber.

4. The pump according to claim 3, wherein the rotor or rotor body, respectively, has, for the secondary flow, at least one return duct and preferably several return ducts, which establish a fluidic connection between the drive chamber and the impeller chamber, wherein the return ducts are advantageously separated from one another via separating elements of the rotor or rotor body, respectively.

5. The pump according to claim 1, wherein the pump comprises a rotationally non-movable axle, wherein the rotor is rotatably mounted on the axle.

6. The pump according to claim 1, wherein the rotor has, in a longitudinal section of the pump, a protrusion for the turbulence reduction, wherein the protrusion protrudes in the radial direction and preferably, with view towards an underside of the rotor, at least partly covers an input of a return duct.

7. The pump according to claim 1, wherein the rotor comprises a rotor cap, wherein the rotor cap is fastened to a lower end of the rotor.

8. The pump according to claim 1, wherein the rotor body is formed in one piece and integrally.

9. The pump according to claim 1, wherein the block housing encloses the rotor block in the radial direction at least along an axial section and at least along a circulation section.

10. The pump according to claim 1, wherein the pump has a printed circuit board for controlling the pump operation, wherein the printed circuit board is arranged on an outer side of the separating wall.

11. The pump according to claim 4, wherein the return ducts are located within the rotor or rotor body, respectively, wherein the rotor or the rotor body, respectively, encloses at least one return duct in a cross section at least axially in sections.

12. The pump according to claim 5, wherein the rotary bearing has an effective axial rotary bearing length DL, wherein the axle has an effective axle length AL, wherein the ratio DL/AL is larger than or equal to 0.4.

13. The pump according to claim 5, wherein the rotary bearing rests against the axle or is groove-free, respectively, along at least one axial section over a full circumference.

14. The pump according to claim 5, wherein the pump has an axle holder, wherein the axle holder is preferably arranged in an upper half or an upper third, respectively, or an upper quarter, respectively, of the axle.

15. The pump according to claim 1, wherein a spider is arranged in the flow direction between the inlet and the impeller, wherein the spider is preferably fastened to the housing or the upper housing part, respectively.

16. The pump according to claim 2, wherein an annular gap runs between a radial outer side of the drive section of the shaft and an inner side of the separating wall, so that the secondary flow path preferably fluidically connects an upper hollow space of the drive chamber to a lower hollow space of the drive chamber.

17. The pump according to claim 2, wherein the separating wall has ribs on the inner side in a lower region of the drive chamber.

18. The pump according to claim 2, wherein the separating wall has a thermoplastic, wherein the separating wall preferably comprises a conductivity additive for increasing the thermal conductivity.

19. The pump according to claim 1, wherein the pump comprises a stator holder, wherein the stator holder preferably comprises a holder flange, wherein the holder flange rests against a housing flange.

20. The pump according to claim 2, wherein the pump comprises a lower housing part, a stator aggregate, a separating wall aggregate and an upper housing part, wherein the stator aggregate has the stator and preferably a stator holder, wherein the separating wall aggregate comprises the separating wall and an axle, wherein the pump can be assembled in the order
lower housing part
stator aggregate
separating wall aggregate
rotor
upper housing part
or in the reverse order.
